(19) United States
(12) Patent Application Publication
(10) Pub. No.: US 2012/0106008 A1
(43) Pub. Date: May 3, 2012

(54) SPIKE SUPPRESSION CIRCUIT AND CONVERSION CONTROL CIRCUIT

(75) Inventors: Li-Min Lee, New Taipei City (TW); Chung-Che Yu, New Taipei City (TW); Shian-Sung Shiu, New Taipei City (TW); Ji-Ming Chen, Wuxi (CN)

(73) Assignee: GREEN SOLUTION TECHNOLOGY CO., LTD., Taipei County (TW)

(21) Appl. No.: 13/192,491

(22) Filed: Jul. 28, 2011

(30) Foreign Application Priority Data
Oct. 29, 2010 (CN) 201010530353.4

(51) Int. Cl. H02H 3/20

(52) U.S. Cl. 361/18; 361/91.5

(57) ABSTRACT

A spike suppression circuit for filtering out voltage oscillation produced by an inductive component and a conversion control circuit are disclosed. The spike suppression circuit includes an energy release path and a detection circuit. One end of the energy release path is coupled to a connection terminal of a circuit, and the other end thereof is coupled to a reference voltage. The detection circuit is coupled to the connection terminal. The detection circuit has a high-pass component for turning on the energy release path when the voltage on the connection terminal has a high-frequency signal.

### CROSS-REFERENCE TO RELATED APPLICATION

This application claims the priority benefit of China application serial no. 201010530353.4, filed on Oct. 29, 2010. The entirety of the above-mentioned patent application is hereby incorporated by reference herein and made a part of this specification.

### BACKGROUND OF THE INVENTION

1. Field of the Invention

The invention generally relates to a spike suppression circuit and a conversion control circuit, and more particularly, to a spike suppression circuit for suppressing a high-frequency oscillation signal produced by an inductive component and a conversion control circuit.

2. Description of Related Art

FIG. 1 is a diagram of a conventional DC-DC buck conversion circuit. The DC-DC buck conversion circuit includes a controller 10, transistors M1 and M2, an inductor L, and an output capacitor Cout. The transistors M1 and M2 are connected in series between an input power Vin and the ground voltage. One end of the inductor L is coupled to the connection point of the transistor M1 and the transistor M2, and the other end thereof is coupled to the output capacitor Cout for outputting an output voltage Vout. The controller 10 generates control signals UG and LG according to the output voltage Vout and a voltage signal Vp at the connection point of the transistors M1 and M2 to respectively control the on/off of the transistors M1 and M2. When the transistor M1 is turned on and the transistor M2 is turned off, a current from the input power Vin flows through the transistor M1 and the inductor L by the path \hat{1}, and is eventually stored in the output capacitor Cout. When the transistor M2 is turned on and the transistor M1 is turned off, the current flows by the path \hat{2}, i.e., flows from the ground voltage to the transistor M2, the inductor L, and is eventually stored in the output capacitor Cout.

Theoretically, when the transistor M1 is turned on and the transistor M2 is turned off, the voltage signal Vp is almost equal to the input power Vin, and when the transistor M2 is turned on and the transistor M1 is turned off, the voltage signal Vp is almost equal to the ground voltage. If the transistors M1 and M2 cannot be turned on/off at the same time point as mentioned above, i.e., the transistors M1 and M2 are turned off during a dead time, the voltage signal Vp can be clamped between Vin+Vd and −Vd through body diodes of the transistors M1 and M2, wherein Vd is the forward turn-on voltage of the body diodes of the transistors M1 and M2. However, high-frequency voltage oscillation may be produced by the inductor L and parasitic inductors and capacitors on the circuits (for example, parasitic capacitors on the transistors M1 and M2). FIG. 2 illustrates the waveforms of control signals and voltage signals in the DC-DC buck conversion circuit in FIG. 1. When the control signal UG shifts from the high level to the low level and the control signal LG shifts from the low level to the high level (i.e., the transistor M2 is turned on and the transistor M1 is turned off), the voltage signal Vp drops to a level lower than −Vd and oscillates around zero voltage (herein the turn-on voltage drop of the transistor M2 is ignored). When the control signal LG shifts from the high level to the low level and the control signal UG shifts from the low level to the high level (i.e., the transistor M1 is turned on and the transistor M2 is turned off), the voltage signal Vp rises to a level higher than Vin+Vd and oscillates around the input power Vin (herein the turn-on voltage drop of the transistor M1 is ignored). Such a phenomenon is usually referred to as a spike, and the transistors M1 and M2 and the body diodes thereof is not fast enough to filter out the voltage oscillation because the frequency of voltage oscillation produced by the inductor L and the parasitic inductors and capacitors on the circuits is very high. In some applications, the amplitude of the high-frequency voltage oscillation may even exceed 0.5*Vin (i.e., the actual voltage range of the voltage signal Vp is from −0.5*Vin to 1.5 Vin).

Aforementioned spike phenomenon will affect the voltage-withstand level of the transistors M1 and M2. Particularly, when the controller 10 is connected to the connection point of the transistor M1 and the transistor M2 (as shown in FIG. 1), the voltage-withstand level of the controller 10 needs to be increased as well. However, the increase in the voltage-withstand level of the controller 10 will cause the cost to be increased. Besides, because the voltage range of the voltage signal Vp varies with different circuit design, it may exceed the withstand voltages of a controller and the transistors. As a result, the lifespan of the circuit may be shorted or the circuit may even be damaged.

### SUMMARY OF THE INVENTION

In a conventional circuit, high-frequency voltage oscillation may be produced by an inductive component (for example, an inductor in a conversion circuit or a parasitic inductor in a circuit) when switching the transistors, and which may shorten the lifespan of the transistors or a circuit receiving the high-frequency voltage oscillation or may even damage the transistors or the circuit. Accordingly, the invention is directed to a spike suppression circuit which can reduce the amplitude of high-frequency voltage oscillation.

The invention provides a spike suppression circuit for filtering out voltage oscillation produced by an inductive component. The spike suppression circuit includes an energy release path and a detection circuit. One end of the energy release path is coupled to a connection terminal of a circuit, and the other end thereof is coupled to a reference voltage. The detection circuit is coupled to the connection terminal and has a high-pass component. The detection circuit turns on the energy release path when the voltage on the connection terminal has a high-frequency signal.

The invention provides a conversion control circuit for controlling a conversion circuit to transmit power from an input power to an output terminal, wherein the conversion circuit includes an inductive component. The conversion control circuit includes at least one switching unit, a control circuit, a driving circuit, and a spike suppression circuit. The control circuit generates at least one duty cycle signal according to a feedback signal representing an output voltage or an output current on the output terminal. The at least one switching unit is coupled to the input power and the conversion circuit. The driving circuit switches the at least one switching unit according to the duty cycle signal to control the amount of the power transmitted to the output terminal, so as to stabilize the output voltage or the output current at a predetermined value. One terminal of the spike suppression circuit is coupled to the at least one switching unit. The spike suppression circuit detects a terminal voltage on aforementioned terminal of the spike suppression circuit, and when the terminal voltage has a high-frequency signal, the spike suppression circuit reduces the amplitude of the high-frequency signal.

The invention provides a conversion control circuit for controlling a conversion circuit to transmit power from an input power to an output terminal, wherein the conversion circuit includes an inductive component. The conversion control circuit includes at least one switching unit, a control circuit, and a spike suppression circuit. The at least one switching unit is coupled to the input power and the conversion circuit. The control circuit has a first detection terminal and a second detection terminal. The first detection terminal receives a feedback signal representing an output voltage or an output current on the output terminal, and the second detection terminal is coupled to the inductive component. The control circuit switches the at least one switching unit according to the feedback signal to control the amount of the power transmitted to the output terminal, so as to stabilize the output voltage or the output current at a predetermined value. One terminal of the spike suppression circuit is coupled to the second detection terminal. The spike suppression circuit suppresses a voltage variation on the second detection terminal so that the voltage on the second detection terminal is not higher than a first predetermined voltage or lower than a second predetermined voltage.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional DC-DC buck conversion circuit.

FIG. 2 illustrates the waveforms of control signals and a voltage signal in the DC-DC buck conversion circuit in FIG. 1.

FIG. 3 is a diagram of a conversion control circuit according to an exemplary embodiment of the invention.

FIG. 4 is a diagram of a spike suppression circuit according to a first embodiment of the invention.

FIG. 5 is a diagram of a spike suppression circuit according to a second embodiment of the invention.

FIG. 6 illustrates the waveform of a voltage signal Vp in the spike suppression circuit in FIG. 3.

FIG. 7 is a diagram of a spike suppression circuit according to a third embodiment of the invention.

FIG. 8 is a diagram of a spike suppression circuit according to a fourth embodiment of the invention.

FIG. 9 is a diagram of a conversion control circuit according to another exemplary embodiment of the invention.

FIG. 10 is a diagram of a DC-DC boost conversion circuit according to an exemplary embodiment of the invention.

FIG. 11 is a diagram of a spike suppression circuit according to the fourth embodiment of the invention.

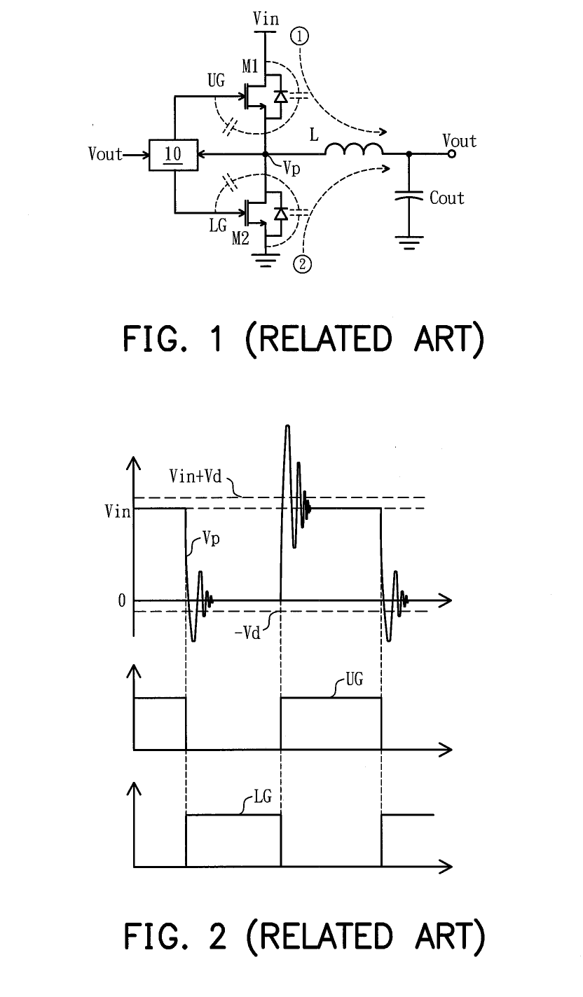

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

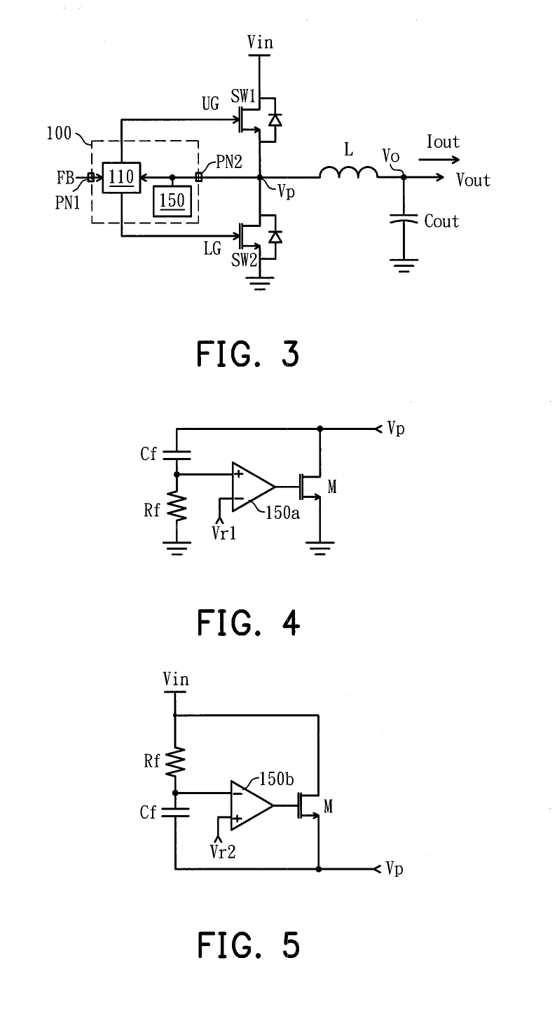

FIG. 3 is a diagram of a conversion control circuit according to an exemplary embodiment of the invention. The conversion control circuit in the present embodiment controls a conversion circuit to transmit power from an input power Vin to an output terminal Vo, so as to supply a stable output voltage Vout or a stable output current Iout. The conversion circuit includes an inductor L and an output capacitor Cout. The conversion control circuit includes switching units SW1 and SW2, a control circuit 110, and a spike suppression circuit 150. The control circuit 110 and the spike suppression circuit 150 may be packaged into a single package as a single controller 100. The switching units SW1 and SW2 are connected in series between the input power Vin and the ground voltage. The connection point of the switching units SW1 and SW2 is coupled to one end of the inductor L, and the other end of the inductor L is coupled to the output capacitor Cout. The control circuit 110 has a first detection terminal PN1 and a second detection terminal PN2. The first detection terminal PN1 is coupled to the output terminal Vo for receiving a feedback signal FB, and the second detection terminal PN2 is coupled to the connection point of the switching units SW1 and SW2 for receiving a voltage signal Vp on the connection point. The feedback signal FB represents the value of the output voltage Vout or the output current Iout on the output terminal Vo. The control circuit 110 switches the switching units SW1 and SW2 according to the feedback signal FB, so as to control the amount of the power transmitted from the input power Vin to the output terminal Vo and stabilize the output voltage Vout or the output current Iout at a predetermined value. One terminal of the spike suppression circuit 150 is coupled to the second detection terminal PN2. The spike suppression circuit 150 suppresses voltage variation on the second detection terminal PN2 so that the voltage on the second detection terminal PN2 is not higher than a first predetermined voltage and/or lower than a second predetermined voltage.

In the present embodiment, the switching units SW1 and SW2 may be metal-oxide-semiconductor field-effect transistors (MOSFET), the first predetermined voltage may be set as being equal to or lower than the drain-source withstand voltage of the switching unit SW2, and the second predetermined voltage may be set as being equal to or higher than the input power Vin minus the drain-source withstand voltage of the switching unit SW1, so that the switching units SW1 and SW2 can be protected. If the voltage-withstand capability of the control circuit 110 is lower than that of the switching units SW1 and SW2, the first predetermined voltage and the second predetermined voltage can be set according to the voltage-withstand capability of the control circuit 110.

FIG. 4 is a diagram of a spike suppression circuit according to a first embodiment of the invention. The spike suppression circuit includes an energy release path and a detection circuit. The energy release path includes a transistor M. The detection circuit includes a capacitor Cf, a resistor Rf, and a comparator 150a. One end of the resistor Rf is grounded, and the other end thereof is connected to the capacitor Cf and the non-inverting input terminal of the comparator 150a. One terminal of the transistor M is connected to another end of the capacitor Cf and the connection point as shown in FIG. 3 for receiving the voltage signal Vp on the connection point, and the other terminal of the transistor M is coupled to a reference voltage (for example, is grounded). The inverting input terminal of the comparator 150a receives a first reference voltage Vr1, and the output terminal thereof is coupled to the control terminal of the transistor M for controlling the on/off of the transistor M. When the voltage signal Vp carries a high-frequency voltage signal, voltage variation of the voltage signal is directly applied to the resistor Rf due to the high-pass feature of the capacitor Cf. When the voltage on the resistor Rf is higher than the first reference voltage Vr1, the comparator 150a outputs a high-level signal to turn on the transistor M, so as to prevent the level of the voltage signal Vp from increasing and limit the level of the voltage signal Vp to be equal to or lower than the first predetermined voltage.

FIG. 5 is a diagram of a spike suppression circuit according to a second embodiment of the invention. The spike suppression circuit includes an energy release path and a detection circuit. The energy release path includes a transistor M. The detection circuit includes a capacitor Cf, a resistor Rf, and a comparator 150b. Unlike that in the spike suppression circuit illustrated in FIG. 4, in the present embodiment, the reference voltage is changed from the ground voltage to the input power Vin, the non-inverting input terminal of the comparator 150b receives a second reference voltage Vr2, and the inverting input terminal thereof is connected to the connection point of the capacitor Cf and the resistor Rf. When the voltage signal Vp carries a high-frequency voltage signal and accordingly the voltage on the connection point of the capacitor Cf and the resistor Rf is lower than the second reference voltage Vr2, the comparator 150b outputs a high-level signal to turn on the transistor M, so as to prevent the level of the voltage signal Vp from dropping and limit the level of the voltage signal Vp to be equal to or higher than the second predetermined voltage.

The spike suppression circuits in the embodiments illustrated in FIG. 4 and FIG. 5 are respectively used for suppressing spikes of over-high voltage and over-low voltage. In real applications, user may filter out spike of over-high voltage or over-low voltage upon the application environment of the circuit or filtered out all together by combining the embodiments illustrated in FIG. 4 and FIG. 5.

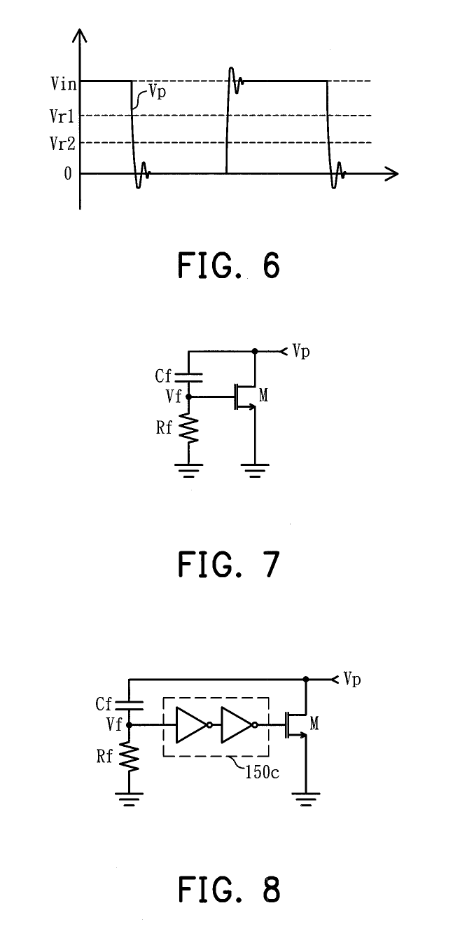

FIG. 6 illustrates the waveform of the voltage signal Vp in the spike suppression circuit in FIG. 3. To be specific, FIG. 6 illustrates the waveform of the voltage signal Vp when the spike suppression circuit 150 in FIG. 3 includes both the spike suppression circuits illustrated in FIG. 4 and FIG. 5. Referring to FIGS. 3-5, when the switching unit SW2 is turned on and the switching unit SW1 is turned off, the voltage signal Vp quickly drops from the input power Vin to 0V. When the voltage signal Vp is lower than the second reference voltage Vr2, the comparator 150b turns on the transistor M to slow down the variation of the voltage signal Vp (i.e., to filter out high-frequency signals) and reduce the amplitude of the voltage oscillation to be equal to or lower than a predetermined value. When the switching unit SW1 is turned on and the switching unit SW2 is turned off, the voltage signal Vp quickly rises from 0V to the input power Vin. When the voltage signal Vp is higher than the first reference voltage Vr1, the comparator 150a turns on the transistor M to slow down the variation of the voltage signal Vp and reduce the amplitude of the voltage oscillation to be equal to or lower than a predetermined value. As described above, the spike suppression circuit provided by the invention can effectively suppress spikes and accordingly protect the switching units SW1 and SW2 and other circuits connected to the connection points between the switching units SW1 and SW2.

FIG. 7 is a diagram of a spike suppression circuit according to a third embodiment of the invention. Compared to the spike suppression circuit illustrated in FIG. 4, the spike suppression circuit in the present embodiment has no comparator 150a. Due to the high-pass feature of the capacitor Cf, most voltage variations caused by high-frequency spikes fall on the resistor Rf, so that the transistor M is turned on and the spikes are suppressed. Accordingly, the comparator can be skipped in the spike suppression circuit provided by the invention so as to reduce the cost of the spike suppression circuit. FIG. 8 is a diagram of a spike suppression circuit according to a fourth embodiment of the invention. Compared to the spike suppression circuit illustrated in FIG. 4, in the present embodiment, the comparator 150a is replaced by a determination circuit 150c which connects two inverters in series. Because the response speed of the inverters is higher than that of the comparator 150a, the spike suppression circuit in the present embodiment offers a better transient voltage suppressing effect.

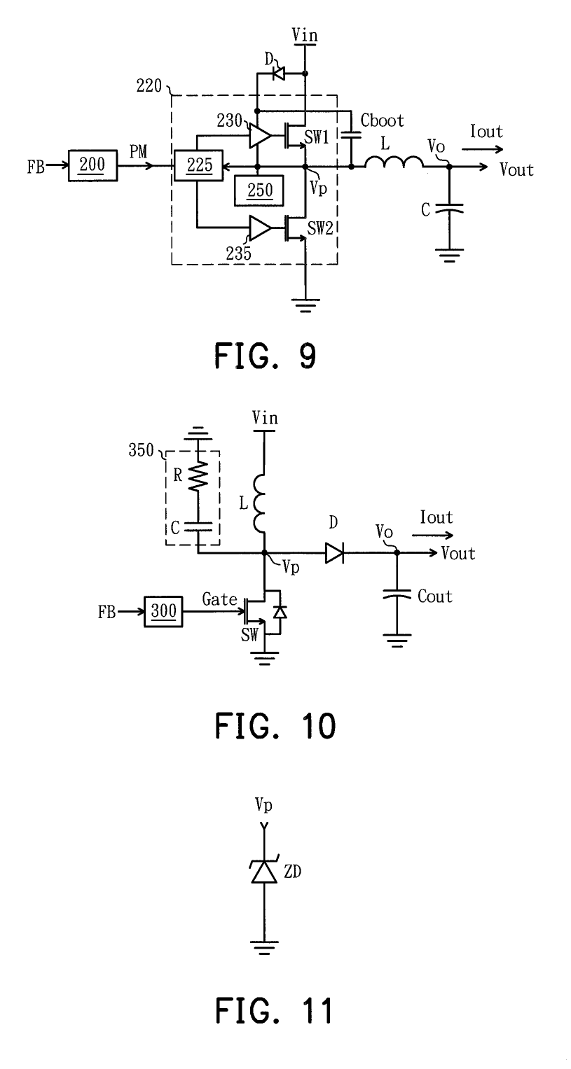

FIG. 9 is a diagram of a conversion control circuit according to another exemplary embodiment of the invention. The conversion control circuit in the present embodiment controls a conversion circuit to transmit power from an input power Vin to an output terminal Vo, so as to supply a stable output voltage Vout or a stable output current Iout. The conversion circuit includes an inductor L and an output capacitor Cout. The conversion control circuit includes a control circuit 200 and a transistor module 220. The control circuit 200 receives a feedback signal FB, wherein the feedback signal FB represents the value of the output voltage Vout or the output current Iout on the output terminal Vo. The control circuit 200 generates at least one duty cycle signal PM for the transistor module 220 according to the feedback signal FB. The duty cycle signal PM may be a pulse width modulated signal, a pulse frequency modulated signal, or a combination thereof. The transistor module 220 includes a driving circuit, switching units SW1 and SW2, and a spike suppression circuit 250. The driving circuit includes a pulse width control circuit 225, a first driving circuit 230, and a second driving circuit 235. In order to allow the first driving circuit 230 to turn on the switching unit SW1 successfully, the first driving circuit 230 is coupled to a bootstrap circuit to provide a voltage higher than the voltage signal Vp. The bootstrap circuit includes a diode D and a boost capacitor Cboot coupled between the input power Vin and the connection point of the switching units SW1 and SW2. The pulse width control circuit 225 is coupled to the connection point of the switching units SW1 and SW2, and which switches the switching units SW1 and SW2 through the first driving circuit 230 and the second driving circuit 235 according to the duty cycle signal PM and the voltage signal Vp, so as to control the power transmitted from the input power Vin to the output terminal Vo and stabilize the output voltage Vout or the output current Tout at a predetermined value. One terminal of the spike suppression circuit 250 is coupled to the connection point of the switching units SW1 and SW2 to suppress the voltage variation on the connection point of the switching units SW1 and SW2, so that the voltage on the connection point of the switching units SW1 and SW2 is not higher than the first predetermined voltage or lower than the second predetermined voltage.

Unlike that in the conversion control circuit illustrated in FIG. 3, the transistor module 220 in FIG. 9 may be a single package such that the voltage-withstand capability of the control circuit 200 needs not to be increased to the input power Vin. Thereby, the voltage-withstand capability of the control circuit 200 can be reduced and accordingly the cost of the entire circuit can be reduced.

Besides the spike suppression circuits described in foregoing embodiments, according to the invention, a regular electrostatic discharge (ESD) circuit may also be directly adopted as a spike suppression circuit such that the surface area of the chip won't be increased. Or, the same transient voltage suppression effect may also be achieved by disposing additional discrete components.

FIG. 10 is a diagram of a DC-DC boost conversion circuit according to an exemplary embodiment of the invention. The DC-DC boost conversion circuit includes a controller 300, a spike suppression circuit 350, a switching unit SW, an inductor L, a diode D, and an output capacitor Cout. One end of the inductor L is coupled to an input power Vin, and the other end thereof is coupled to the anode of the diode D and one terminal of the switching unit SW. The other terminal of the switching unit SW is grounded. The cathode of the diode D is coupled to one end of the output capacitor Cout to form an output terminal Vo. The controller 300 receives a feedback signal FB and switches the switching unit SW according to the feedback signal FB, wherein the feedback signal FB represents the value of an output voltage Vout or an output current Iout on the output terminal Vo. Thereby, the controller 300 can control the amount of the power transmitted from the input power Vin to the output terminal Vo and stabilize the output voltage Vout or the output current Iout at a predetermined value. The spike suppression circuit 350 includes a resistance component R and a capacitance component C that are connected in series with each other. The spike suppression circuit 350 is coupled between the connection point of the inductor L and the switching unit SW and the ground, and which suppresses variations of the voltage Vp on the connection point of the inductor L and the switching unit SW to make sure that the voltage Vp is not higher than a first predetermined voltage or lower than a second predetermined voltage.

FIG. 11 is a diagram of a spike suppression circuit according to the fourth embodiment of the invention. The spike suppression circuit in the present embodiment includes a Zener diode ZD. One end of the Zener diode ZD is coupled to a connection point on which spikes are to be suppressed, and the other end thereof is grounded, so that the peak voltage level of the voltage signal Vp is suppressed to be around the breakdown voltage of the Zener diode ZD.

In summary, high-frequency voltage oscillation may be produced by an inductive component (for example, an inductor, a transformer, a piezo transformer, a parasitic inductor, or any other component with an inductance value in a circuit) when switching units are switched, and which may shorten the lifespan of the circuit. Accordingly, the invention provides a spike suppression circuit which can reduce the amplitude of high-frequency voltage oscillation in spikes, so that the lifespan of circuits and devices can be prolonged.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A spike suppression circuit, for filtering out voltage oscillation produced by an inductive component, the spike suppression circuit comprising:
an energy release path, having one end coupled to a connection terminal of a circuit and another end coupled to a reference voltage; and
a detection circuit, coupled to the connection terminal, having a high-pass component, wherein the detection circuit turns on the energy release path when a voltage on the connection terminal has a high-frequency signal.

2. The spike suppression circuit according to claim 1, wherein the detection circuit comprises a determination unit, and the detection circuit turns on the energy release path when the determination unit determines that an amplitude of the high-frequency signal is higher than a predetermined value.

3. The spike suppression circuit according to claim 2, wherein the energy release path comprises a transistor.

4. The spike suppression circuit according to claim 2, wherein the determination unit comprises an inverter or a comparator.

5. The spike suppression circuit according to claim 2, wherein the detection circuit further comprises a resistance component and a capacitance component, the resistance component and the capacitance component are coupled in series between the connection terminal and the reference voltage, and a connection point of the resistance component and the capacitance component is coupled to the determination unit.

6. The spike suppression circuit according to claim 1, wherein the energy release path comprises a transistor.

7. A conversion control circuit, for controlling a conversion circuit to transmit power from an input power to an output terminal, wherein the conversion circuit comprises an inductive component, the conversion control circuit comprising:
at least one switching unit, coupled to the input power and the conversion circuit;
a control circuit, for generating at least one duty cycle signal according to a feedback signal representing an output voltage or an output current on the output terminal;
a driving circuit, for switching the at least one switching unit according to the duty cycle signal, so as to control an amount of the power transmitted to the output terminal and stabilize the output voltage or the output current at a predetermined value; and
a spike suppression circuit, having one terminal coupled to the at least one switching unit, for detecting a terminal voltage on the terminal and when the terminal voltage has a high-frequency signal, reducing an amplitude of the high-frequency signal.

8. The conversion control circuit according to claim 7, wherein the spike suppression circuit has a high-pass component.

9. The conversion control circuit according to claim 7, wherein the spike suppression circuit comprises a determination unit and a transistor, and the transistor is turned on when the amplitude of the high-frequency signal is higher than a predetermined value.

10. The conversion control circuit according to claim 7, wherein the spike suppression circuit comprises a resistance component and a capacitance component that are connected in series with each other, and the resistance component and the capacitance component are coupled between the at least one switching unit and a reference voltage.

11. The conversion control circuit according to claim 7, wherein the at least one switching unit, the driving circuit, and the spike suppression circuit are packaged in a single packaging structure.

12. A conversion control circuit, for controlling a conversion circuit to transmit power from an input power to an output terminal, wherein the conversion circuit comprises an inductive component, the conversion control circuit comprising:
at least one switching unit, coupled to the input power and the conversion circuit;
a control circuit, having a first detection terminal and a second detection terminal, wherein the first detection terminal receives a feedback signal that represents an output voltage or an output current on the output terminal, the second detection terminal is coupled to the inductive component, and the control circuit switches the at least one switching unit according to the feedback signal to control an amount of the power transmitted to the output terminal and stabilize the output voltage or the output current at a predetermined value; and
a spike suppression circuit, having one terminal coupled to the second detection terminal, for suppressing voltage variations on the second detection terminal so that a voltage on the second detection terminal is not higher than a first predetermined voltage or lower than a second predetermined voltage.

13. The conversion control circuit according to claim 12, wherein the spike suppression circuit comprises a Zener diode.

14. The conversion control circuit according to claim 12, wherein the spike suppression circuit comprises a resistance component and a capacitance component that are connected in series with each other.

15. The conversion control circuit according to claim 12, wherein the spike suppression circuit is an electrostatic discharge (ESD) circuit of the control circuit.
